(19) United States
(12) Patent Application Publication
(10) Pub. No.: US 2017/0333799 A1
(43) Pub. Date: Nov. 23, 2017

(54) WATER PLAYING SYSTEM TO BE OPERATED BY HUMAN SENSING AND OPERATION METHOD THEREOF

(71) Applicants: DPI CO., LTD., Seoul (KR); DREAMPARK INTERNATIONAL, Suwanee, GA (US)

(72) Inventor: Jeong Kyun PARK, Seoul (KR)

(73) Assignees: DREAMPARK INTERNATIONAL, Suwanee, GA (US); DPI CO., LTD., Seoul (KR)

(21) Appl. No.: 14/766,629

(22) PCT Filed: Nov. 19, 2014
(86) PCT No.: PCT/KR2014/011122

§ 371 Date: Aug. 7, 2015

(51) Int. Cl. A63G 31/00; E04H 4/14; G09G 3/20; E04H 4/12; G09G 3/36; G09G 3/00; G09G 3/32

(52) U.S. Cl. CPC A63G 31/007; G09G 3/2092; E04H 4/14; E04H 4/12; G09G 3/002; G09G 3/32; G09G 3/36; G09G 2300/026

(57) ABSTRACT

A water playing system includes an infrared sensor for sensing people, a display module for displaying still image or moving image, a jet module for jetting the water into the water playing pool, and a control computer for controlling to display the still image or the moving image by the display module and to jet the water by the jet module when the people are sensed by the infrared sensor.

### CROSS-REFERENCE(S) TO RELATED APPLICATION

This application is a National Stage Application of PCT International Patent Application No. PCT/KR2014/011122 filed on Nov. 19, 2014, under 35 U.S.C. §371, which is hereby incorporated by reference in its entirety.

### BACKGROUND OF THE INVENTION

### Field of the Invention

The present invention relates to a water playing system and an operation method thereof, and more particularly, to a water playing system which operates the water playing facility which is operated by human sensing and an operation method thereof, and further more particularly, to a water playing system which projects an image to a water playing pool, outputs music or imitative sounds, jets the water through a nozzle, or emits an illumination light to the water playing pool upon sensing the people in the water playing pool and an operation method thereof.

### Description of the Related Art

In general, a conventional water playing system is provided with various facilities such as a huge bucket for pouring a lot of water on the people in the water playing pool or a long slide tube connected to the water playing pool.

These facilities for playing in water are constructed so that the people can directly operate or manual operate the bucket or other facilities for playing in water.

Among these various systems for playing in water, there are many comparatively safe facilities for playing in water which does not require the people's direct operation for driving control or manual operation. However, most of the driving of the water playing system still depend on the manual operation or driving operation by the operators.

Recently, there is a tendency that the pools for playing in water becomes diversified such as to be large or small and many pools are required, and these pools for playing in water are spatially too wide to entirely depend on the individual operation of the operator and the number of the facilities are increasing, so that there are occurring difficulties in reality. The confirmation entirely done by the operators whether the people use the facilities for playing in water through CCTV and the remote operation on the facilities inevitably have limitations.

As such, recently, the facilities for playing in water gradually becoming large and diversified require a scheme which enables the people more conveniently and easily use the facilities for playing in water without the aid of the operator. Means different from the conventional one is required which enables the people to intuitionally use the facilities for playing in water without direct operation.

### SUMMARY OF THE INVENTION

An object of the present invention is to provide a water playing system to be operated by human sensing.

Another object of the present invention is to provide an operation method for a water playing system to be operated by human sensing.

An aspect of the present invention is directed to a water playing system to be operated by human sensing including: an infrared sensor for sensing the people; a display module for displaying still image or moving image; a jet module for jetting the water into the water playing pool; and a control computer for controlling to display the still image or the moving image by the display module and to jet the water by the jet module when the people are sensed by the infrared sensor.

The control computer may be configured to drive and control the display module or the jet module by being interlocked to the position of the people sensed by the infrared sensor.

The display module may be provided with a plurality of LCD (liquid crystal display) panels or a plurality of LED (light emitting diode) panels provided at the side of the water playing pool or provided below the reinforced glass bottom surface of the water playing pool.

The jet module may be configured in such a way that a plurality of nozzles are distributed between the plurality of LCD panels or the plurality of LED panels.

The display module may be provided with a projector arranged at a predetermined distance above the water playing pool so as to project the still image or moving image to the bottom of the water playing pool.

The water playing system to be operated by human sensing may further comprise a speaker for outputting the music or the imitative sounds by the control of the computer when the people are sensed by the infrared sensor.

The jet module may comprise: a nozzle for jetting the water; a solenoid valve for driving and controlling the pressure of the water and the amount of the water to be jetted through the nozzle; a motor pump for pumping and providing the water so that the water is jetted through the nozzle; and a control panel for driving and controlling the motor pump and the solenoid valve by the control of the control computer when the people are sensed by the infrared sensor.

The water playing system to be operated by human sensing may further comprise a motion sensor configured to sense a predetermined motion of the people in the water playing pool so that the control computer can control the display module, the jet module or the speaker according to the motion.

Another aspect of the present invention is directed to an operation method of the water playing system to be operated by human sensing including: sensing the people by an infrared sensor; determining whether the people are sensed by the infrared sensor by a control computer; and displaying the still image or the moving image by a display module or jetting the water to a water playing pool by a jet module under the control of the control computer, if the people are sensed as a result of the determining.

The operation method of the water playing system to be operated by human sensing may further comprise: sensing the motion of the people by a motion sensor; comparing the sensed motion and a predetermined motion and determining by the control computer; and driving and controlling the display module or the jet module by the control computer according to the result of the determining.

The step of displaying the still image or the moving image by a display module or jetting the water to a water playing pool by a jet module under the control of the control computer, if the people are sensed as a result of the determining may comprise driving and controlling the display module or the jet module by the control computer by being interlocked to the position of the people sensed by the infrared sensor.

### Effect of the Present Invention

According to the water playing system to be operated by human sensing and a method of operation thereof described above, there is an effect that even if the operator of the facility for playing in water or the people using the facility do not separately operate, if the people at the water playing pool are sensed by the infrared camera, various facilities for playing in water can be automatically operated such as the image is projected to the water playing pool, the music or sound effects is output, or the water is jetted.

These automatic operations due to the automatic sensing can be accomplished according to a series of predetermined scenarios, and accordingly separate operator is not necessary, so that there is an effect that the maintenance/administration of the facility for playing in water becomes easy.

In addition, there is an effect that the interest can be added by projecting an interesting image or moving image such as shark or dolphin to the bottom of the water playing pool, and in addition to this, a new theme water playing pool can be formed by adding sound effects and music.

Meanwhile, there is an effect that a desired environment of playing in water can be made in the water playing pool without the aid of an operator, by enabling various operations in the water playing pool such as when the people using the water playing pool take a predetermined motion, changing the image or moving image to other image or moving image or interrupting the projection of moving image or image by sensing the motion, or changing to a new music or making the water jet stronger, weaker, or interrupting the water jet.

Therefore, the user of the facility for playing in water can use and enjoy the water playing pool very conveniently without the aid of the operator.

### BRIEF DESCRIPTION OF THE DRAWINGS

The above and other aspects, features and advantages of certain exemplary embodiments of the present invention will be more apparent from the following description taken in conjunction with the accompanying drawings, in which:

FIG. 1 is a block diagram of a water playing system to be operated by human sensing according to an embodiment of the present invention;

FIG. 2 is a schematic diagram of the water playing system to be operated by human sensing according to an embodiment of the present invention;

FIGS. 3 and 4 are views illustrating a display image and a water jet shape according to an embodiment of the present invention; and

FIG. 5 is a flow diagram of an operation method of the water playing system to be operated by human sensing according to an embodiment of the present invention.

### DETAILED DESCRIPTION OF EXEMPLARY EMBODIMENTS

The present invention may be applied to various changes and have various embodiments, and specific embodiments will be illustrated in the drawings and described in detail herein. However, this is not intended to limit the present invention to the particular form, but it should be construed to include all modifications, equivalents, and substitutes included in the spirit and the technical scope of the present invention. Like reference numerals are used for like elements when the drawings are explained. Although the terms “first, second, A, B, etc. may be used herein to describe various constituent elements, these elements should not be limited by these terms. These terms are only used to distinguish one element from another element. For example, a first element may be termed a second element, and similarly a second element may also be termed a first element, without departing from the scope of right of the present invention. The terms “and/or” include any and all combinations of a plurality of the associated described items.

When it is stated that a constituent element is “connected” or “coupled” to another constituent element, although it may be directly connected or coupled to the another element, it should be construed that other constituent element may exist between the two elements. Whereas, when it is stated that a constituent element is “directly connected” or “directly coupled” to another constituent element, it should be construed that other constituent element does not exist between the two elements.

The terminology used herein is for the purpose of describing particular embodiments only and is not intended to be limiting. As used herein, the singular forms “a,” “an,” and “the” are intended to include the plural forms, unless the content clearly indicates otherwise. It should be further understood that the terms “comprises” or “includes” when used in this specification, specify the presence of stated features, numerals, steps, operations, elements, components, or combinations thereof, but do not preclude the presence or addition of one or more other features, numerals, steps, operations, elements, components, combinations thereof.

Unless otherwise defined, all terms including technical and scientific terms used herein have the same meaning as commonly understood by person having ordinary skill in the art to which this disclosure belongs. It will be further understood that terms, such as those defined in commonly used dictionaries, should be interpreted as having a meaning that is consistent with their meaning in the context of the relevant art, and should not be interpreted in an idealized or overly formal sense unless expressly so defined herein.

Hereinafter, a preferred embodiment according to the present invention will be described in detail with reference to the accompanying drawings.

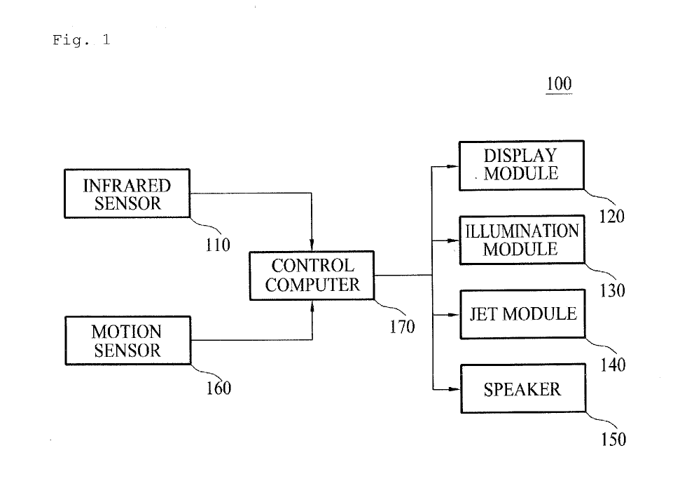

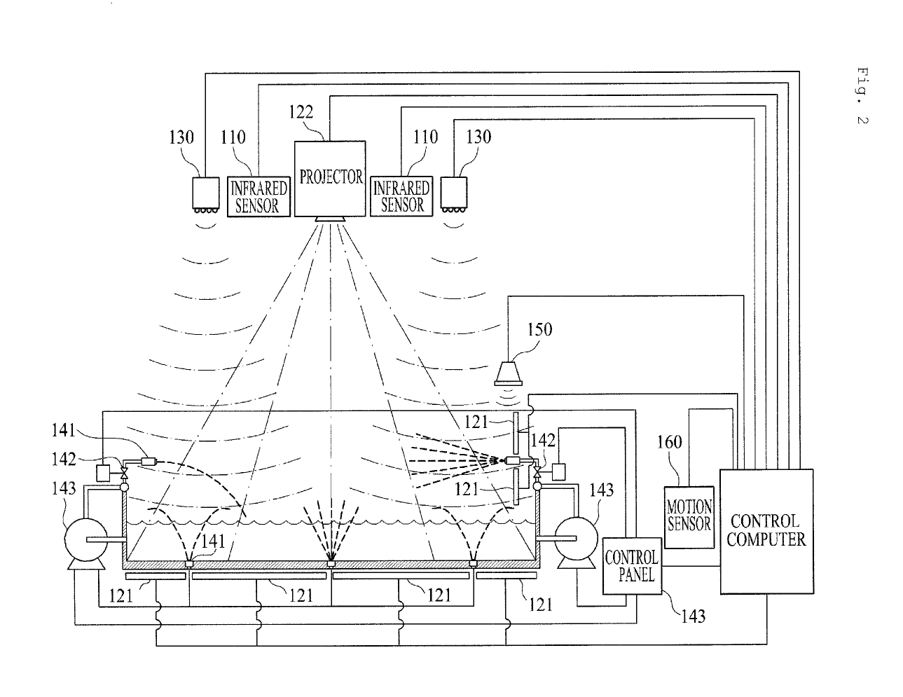

FIG. 1 is a block diagram of a water playing system to be operated by human sensing according to an embodiment of the present invention, and FIG. 2 is a schematic diagram of the water playing system to be operated by human sensing according to an embodiment of the present invention.

Referring to FIGS. 1 and 2, the water playing system 100 to be operated by human sensing according to an embodiment of the present invention (hereinafter, referred to as “system for playing in water”) includes: an infrared sensor 110, a display module 120, an illumination module 130, a jet module 140, a speaker 150, a motion sensor 160, and a control computer 170.

The water playing system 100 is configured such that even if there is no separate operator or administrator at the water playing pool, when a user enters the water playing pool, it is automatically sensed by the infrared sensor 110, and the display module 120, illumination module 130 and jet module 140 which are various facilities for playing in water of the water playing pool are operated.

The water playing system 100 may add interests to the user by projecting various still images or moving images such as a shark, a dolphin, or an octopus to the bottom surface or the like of the water playing pool through the display module 120.

In addition, necessary illumination may be automatically emitted to the water playing pool through the illumination module 130 according to the day or night, so that the user can enjoy through the illumination light necessary for playing in water or can listen and enjoy the imitative sound or music necessary to match the moving image, the illumination light, or the like through the speaker 150.

Meanwhile, the water playing system 100 is constructed such that when the user takes a motion which can directly operate and control the water playing facility, the motion sensor 160 can sense the motion to operate and control each of the water playing facilities. The user may directly control the play environment of the water playing pool without the aid of the operator. For example, the water playing system enables the user to operate various controls such as raising music or imitative sound, changing the color of the illumination light, or changing images or moving images of dolphins to tropical fishes.

As an example of the motion, when swinging right hand, it is possible to select the specific play facility while changing play facilities one by one, whereas when swinging left hand, it is possible to select the contents of relevant play facility while changing the contents one by one. As such, it is possible for the user of the water playing facility to directly control the environment of the water playing pool.

Hereinafter, the detailed configuration will be described.

The infrared sensor 110 is configured to sense the people, and may sense the people existing in the water playing pool. The infrared sensor 110 may be provided at a predetermined distance above the water playing pool.

It is preferred that the infrared sensor 110 is constructed not only to sense the people but also to sense the number of people or the distribution of the people according to the movement of the people.

The display module 120 may be composed of an LCD (liquid crystal display) panel 121, an LED (light emitting diode) module 121, or a projector 122.

The display module 120 may display the octopus, the shark, a whale, or other various still images or moving images.

The display module 120 may be provided at the side of the water playing pool or at the bottom of or above the water playing pool to be separated from each other.

In case where the display module 120 is provided at the bottom, it may be provided below the bottom composed with a reinforced glass.

The LCD panel 121 or the LED panel 121 may be provided at the upper end of the side or at the bottom of the water playing pool, and the projector 122 may be provided above the water playing pool so as to project the image to the bottom of the water playing pool.

The still image or the moving image may be various water environments such as the shark, the whale, the tropical fish, seaweed, submerged rock, and the like.

The projector 120 may project the still image or the moving image under the control of the computer 170.

As these images, the shark or dolphin following the users according to the distribution or position of the users sensed by the infrared sensor 110 may be projected, or the tropical fish avoiding the users may be projected. This may be realized by the control of the control computer 170 which can use the information of the infrared sensor 110.

The illumination module 130 may be provided to be spaced apart from above the water playing pool.

The illumination module 130 may be constructed to emit the illumination light toward the water playing pool by the control of the control computer 170 when the people are sensed by the infrared sensor 110.

The illumination module 130 may emit the illumination light by combining it with various colors of illumination lights, and the illumination light matching the image of the display module 120 may be emitted. This may be realized according to the scenario of the control computer 170.

The jet module 140 may be composed of a nozzle 141, a solenoid valve 142, a motor pump 143, and a control panel 144.

The jet module 140 may be composed to jet the water to the water playing pool.

The jet module 140 may jet the water on the sculpture at the side of the water playing pool, or jet the water at the space between plural display modules 120, or at the bottom surface of the water playing pool, or from above the water playing pool according to the position of the nozzle 141.

The nozzle 141 may be configured to jet the water in various forms such as a spray or a direct jet water stream.

The solenoid valve 142 may be configured to operate and control the water pressure or the amount of water to be jetted through the nozzle 141. The solenoid valve 142 may be operated by changing the pressure of the water according to the music or image.

The motor pump 143 may be configured to pump the water and provide it to the solenoid valve 142 so as to let the water to be jetted through the nozzle 141.

The control panel 144 is a driving panel to operate and control the solenoid valve 142 and the motor pump 143, and drives and controls them according to the instruction of the control computer 170. The control panel 144 may operate the solenoid valve 142 or the motor pump 143 as if it is a music fountain according to the scenario of the control computer 170.

The speaker 150 may be provided at a predetermined distance from the water playing pool, and can be provided above or at the side of the water playing pool.

The speaker 150 may be configured to output the music or imitative sound by the control of the control computer 170 when the people are sensed by the infrared sensor 110. When a dolphin image is projected according to the scenario of the control computer 170, the dolphin sound can be emitted and a calm wave sound or music can be emitted.

The motion sensor 160 may be provided at a predetermined distance from the water playing pool, and may be configured to sense the predetermined motion of the people in the water playing pool.

At this time, the control computer 170 may be configured to drive and control at least one of the display module 120, the illumination module 130, the jet module 140, and the speaker 150 according to the motion sensed by the motion sensor 160.

Meanwhile, the control computer 170 may be configured to drive and control at least one of the display module 120, the illumination module 130, the jet module 140 and the speaker 150 according to sensing of the people by the infrared sensor 110.

The control computer 170 is configured to display various images on the display module 120, to emit the illumination light by controlling the illumination module 130, or to jet the water in various form by using the jet module 140 and output the speech or sound through the speaker 150 at the time of sensing the people.

The control computer 170 may be configured to be interlocked to the display module 120, the illumination module 130, the jet module 140 and the speaker 150 and control them according to the specific scenario.

The control computer 170 may be configured to control the display module 120, the illumination module 130, the jet module 140 and the speaker 150 by being interlocked to the position of the people sensed by the infrared sensor 110. That is, the example can be given such that the water is jetted to the place where the people exist, the shark image follows the position of movement of the people, or the water is jetted from the image whale.

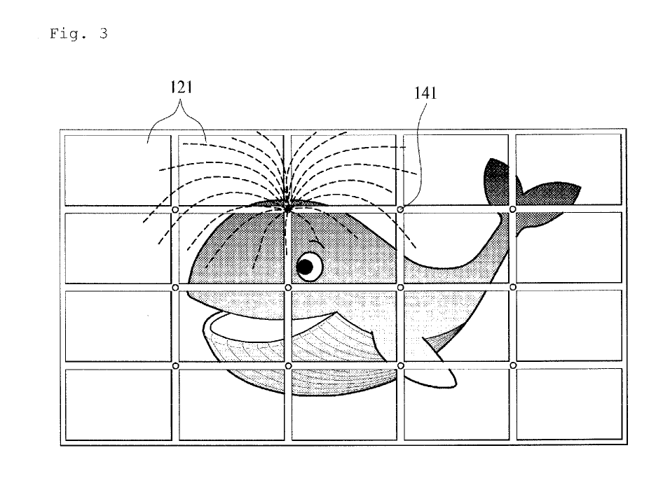

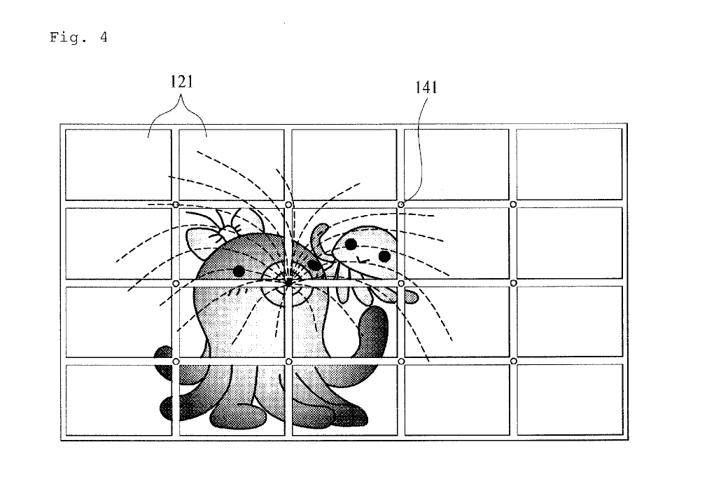

FIGS. 3 and 4 are exemplary drawings of a display image and a water jet shape according to an embodiment of the present invention.

Referring to FIG. 3, it can be seen that the whale is shown at the LCD panel 121 or LED panel 121 provided at the bottom surface of the water playing pool. Furthermore, it can be seen that the water is jetted from the back of the image whale by the nozzles 141 arranged to be distributed between them. As such, it can be seen that the image and the jetted water are interlocked with each other.

Referring to FIG. 4, it can be seen that the octopus is shown at the LCD panel 121 or LED panel 121 provided at the bottom surface of the water playing pool. Furthermore, it can be seen that the ink water of the image octopus is jetted from the nozzles 141 arranged to be distributed between them.

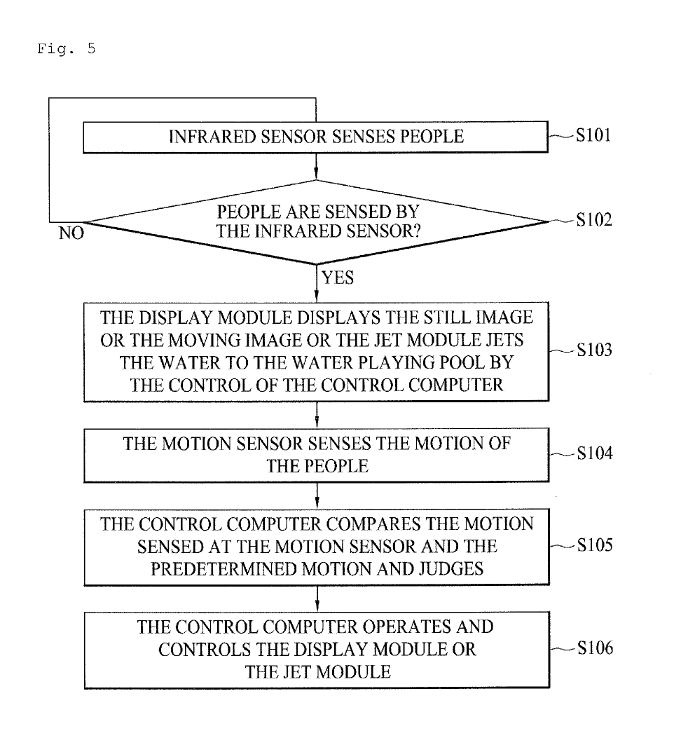

FIG. 5 is a flow diagram of an operation method of the water playing system to be operated by human sensing according to an embodiment of the present invention.

Referring to FIG. 5, the infrared sensor 110 senses people (S101).

Next, the control computer 170 determines whether the people are sensed by the infrared sensor 110 (S102).

As a result of the determining, if the people are sensed, the display module 120 displays the still image or the moving image or the jet module 140 jets the water to the water playing pool by the control of the control computer 170 (S103).

Here, the control computer 170 may be configured to drive and control the display module 120 or the jet module 140 by being interlocked to the position of the people sensed by the infrared sensor 110.

Next, the motion sensor 160 senses the motion of the people (S104).

Next, the control computer 170 compares the motion sensed by the motion sensor 160 and the predetermined motion and determines (S105).

Here, the control computer 170 drives and controls the display module 120 or the jet module 140 according to the result of the determining (S106).

Next, the motion sensor 160 senses the predetermined motion of the people in the water playing pool (S103).

At this time, if the motion is sensed, at least one of the projector 120, the LED module 130, the motor pump 143, the solenoid valve 142 and the speaker 150 are operated under the control of the computer 170, corresponding to the previously sensed motion (S104).

### AVAILABILITY IN THE INDUSTRY

The water playing system to be operated by human sensing and an operation method thereof according to the present invention is a structure with which various environments can be automatically formed in the water playing pool without the aid of the operator and the user can directly change and use the environment of playing in water during playing in water, and has the availability in the industry.

While the invention has been shown and described with reference to exemplary embodiments thereof, it will be understood by those skilled in the art that various changes in form and details may be made therein without departing from the spirit and scope of the invention as defined by the appended claims. Therefore, the scope of the invention is defined not by the detailed description of the invention but by the appended claims, and all differences within the scope will be construed as being included in the present invention.

1. A water playing system to be operated by human sensing including:
an infrared sensor for sensing the people;
a display module for displaying still image or moving image;
a jet module for jetting the water into the water playing pool; and
a control computer for controlling to display the still image or the moving image by the display module and to jet the water by the jet module when the people are sensed by the infrared sensor.

2. The system of claim 1, wherein the control computer is configured to drive and control the display module or the jet module by being interlocked to the position of the people sensed by the infrared sensor.

3. The system of claim 2, wherein the display module is provided with a plurality of LCD (liquid crystal display) panels or a plurality of LED (light emitting diode) panels provided at the side of the water playing pool or provided below the reinforced glass bottom surface of the water playing pool.

4. The system of claim 3, wherein the jet module is configured in such a way that a plurality of nozzles are distributed between the plurality of LCD panels or the plurality of LED panels.

5. The system of claim 1, wherein the display module is provided with a projector arranged at a predetermined distance above the water playing pool so as to project the still image or moving image to the bottom of the water playing pool.

6. The system of claim 1, further comprising a speaker for outputting the music or the imitative sounds by the control of the computer when the people are sensed by the infrared sensor.

7. The system of claim 1, wherein the jet module comprises:
a nozzle for jetting the water;
a solenoid valve for driving and controlling the pressure of the water and the amount of the water to be jetted through the nozzle;
a motor pump for pumping and providing the water so that the water is jetted through the nozzle; and
a control panel for driving and controlling the motor pump and the solenoid valve by the control of the control computer when the people are sensed by the infrared sensor.

8. The system of claim 1, further comprising a motion sensor configured to sense a predetermined motion of the people in the water playing pool so that the control computer can control the display module, the jet module or the speaker according to the motion.

9. An operation method of the water playing system to be operated by human sensing comprising:
sensing the people by an infrared sensor;
determining whether the people are sensed by the infrared sensor by a control computer; and
displaying the still image or the moving image by a display module or jetting the water to a water playing pool by a jet module under the control of the control computer, if the people are sensed as a result of the determining.

10. The method of claim 9, further comprising:
sensing the motion of the people by a motion sensor;
comparing the sensed motion and a predetermined motion and determining by the control computer; and
driving and controlling the display module or the jet module by the control computer according to the result of the determining.

11. The method of claim 10, wherein the step of displaying the still image or the moving image by a display module or jetting the water to a water playing pool by a jet module under the control of the control computer, if the people are sensed as a result of the determining comprises driving and controlling the display module or the jet module by the control computer by being interlocked to the position of the people sensed by the infrared sensor.
